(19) United States
(12) Patent Application Publication
(10) Pub. No.: US 2021/0348542 A1
(43) Pub. Date: Nov. 11, 2021

(54) SEALING SYSTEM AND MOTOR VEHICLE COMPONENT COMPRISING SAID SEALING SYSTEM

(71) Applicants: Xiaobing Yu, Ostfildern (DE); Wojtek Kolasinski, Reutlingen (DE)

(72) Inventors: Xiaobing Yu, Ostfildern (DE); Wojtek Kolasinski, Reutlingen (DE)

(73) Assignee: ElringKlinger AG, Dettingen (DE)

(21) Appl. No.: 17/380,282

(22) Filed: Jul. 20, 2021

Related U.S. Application Data
(63) Continuation of application No. PCT/EP2020/051422, filed on Jan. 21, 2020.

(30) Foreign Application Priority Data
Jan. 21, 2019 (DE) 102019101374.7

(51) Int. Cl. F01N 13/18; F16J 15/32

(52) U.S. Cl. CPC F01N 13/1827; F16J 15/32; F01N 13/1811

(57) ABSTRACT

In order to improve a sealing system, particularly for sealing against hot gas, it is proposed that it comprise a sealing element or a plurality of sealing elements and a support device for the sealing element or for the sealing elements, wherein the sealing system is constructed such that the one or at least one sealing element is arranged on the support device with play in at least one sealing state of the sealing system.

### CROSS-REFERENCE TO RELATED PATENT APPLICATIONS

This application is a continuation of international application number PCT/EP2020/051422 filed on 21 Jan. 2020 and claims the benefit of German application No. 10 2019 101 374.7 filed on 21 Jan. 2019.

This patent application relates to the subject matter disclosed in and claims the benefit of international application PCT/EP2020/051422, filed 21 Jan. 2020, and German application No. 10 2019 101 374.7, filed 21 Jan. 2019, the teachings and disclosure of which are hereby incorporated in their entirety by reference thereto for all purposes.

### BACKGROUND OF THE INVENTION

The invention relates to a sealing system, particularly a sealing system for sealing against a hot gas, for example, the exhaust gases of a combustion engine.

For example, the sealing system is a metallic sealing system.

In particular, the sealing system is a sealing system for applications in motor vehicles. In particular, the sealing system is intended for an exhaust gas system and/or part of an exhaust gas system, wherein the exhaust gas system is in particular an exhaust gas system for the exhaust gases of a combustion engine. For example, the sealing system is intended for a turbocharger or part of a turbocharger. In some embodiments, the sealing system is intended for an exhaust manifold or a part thereof.

Thus, the invention also relates to a motor vehicle component incorporating a sealing system, in particular, one of the previously mentioned components comprising a sealing system.

The object of the invention consists in providing an improved sealing system.

### SUMMARY OF THE INVENTION

In accordance with embodiments of the invention, this object is achieved by a sealing system, particularly a sealing system for sealing against hot gas which comprises a sealing element or a plurality of sealing elements and a support device for the sealing element or for the plurality of sealing elements, wherein the sealing system is formed such that the one or at least one sealing element is arranged on the support device with play in at least one sealing state of the sealing system. In the case of embodiments with a plurality of sealing elements, it is particularly advantageous if a plurality, all for example, of the plurality of sealing elements are arranged on the support device with play in the sealing state.

In accordance with embodiments of the invention, the object is also achieved by a motor vehicle component, in particular a part of an exhaust gas system incorporating a previously described sealing system.

In particular, an advantage of the invention is to be seen in that the one or at least one sealing element is arranged on the support device with play in the sealing state and thus the one or the at least one sealing element has some free space within the play in order to move about such as to achieve better adaptation to the components that are to be sealed for example and to align itself therewith accordingly and/or to provide some free space within the degree of play in order to compensate for the differing thermal expansion behaviours of the support device and the one or the at least one sealing element and thereby preferably avoid or at least reduce the stress therebetween.

For example, due to the arrangement with play of the one or the at least one sealing element on the support device, stresses therebetween which could result from different rigidities of the support device and the one or the at least one sealing element are at least reduced, preferably, substantially prevented.

For example, one advantage of the invention is that, due to the arrangement of the sealing element on the support device with play, forces between the sealing element and the support device and in particular transverse forces relative to a seal axis of the sealing system are at least reduced, preferably, are substantially avoided. Forces of this type can occur for example, if the sealing element is heated up by hot gases and, due to this heating process, thermally expands differently from the support device. The differing thermal expansion occurs in particular due to the different levels of heating of the sealing element which comes substantially directly into contact with the hot gases, and the support device which in particular is not directly exposed to the hot gases. Moreover for example, the thermal expansion of the sealing element and the support device are different since they are formed from materials with different coefficients of thermal expansion.

One advantage of the solution in accordance with the invention in particular is that, due to the provision of the support device and in particular of a support section thereof, one can dispense with a groove in the components that are to be sealed since a of positioning of the sealing element and/or the main force connection and/or the adherence to a minimum clearance between the components that are to be sealed is achieved by the provision of the support device. Consequently, the sealing system is employable more flexibly and in particular for example, the components that are to be sealed can be manufactured in a constructionally simpler manner.

In particular, due to the arrangement with play, smaller irregularities between the sealing element and the support device are compensable and/or a different behaviour thereof in the sealing state is compensable so that greater tolerances can be allowed for and thus more economical production of the sealing system is made possible.

In the case of a plurality of sealing elements, provision is preferably made for at least some of them, all of them for example, to exhibit a same feature or a plurality of like features. In particular, an arrangement of some of the plurality of sealing elements, in particular, an arrangement of all of the plurality of sealing elements exhibits a same feature or a plurality of like features.

Hereinafter, for the sake of a simpler description and to avoid repetitions, a reference to “the sealing element” is to be understand as being a reference to the one sealing element or to a sealing element of the plurality of sealing elements, preferably, to some of the plurality of sealing elements, for example, all of the sealing elements. Thus for example, the formulation that the sealing element exhibits a feature is to be understand as meaning that the one sealing element or at least one sealing element of the plurality of sealing elements exhibits this feature and/or that some of the plurality of sealing elements, for example all of the sealing elements exhibit this feature.

Up to now, no particular details have been given in regard to the arrangement of the sealing element on the support device with play.

In a particularly preferred embodiment, provision is made for the sealing system to be formed in such a way that the sealing element and the support device are arranged such as to be moveable relative to each other at least in the sealing state. Thus, in accord with the preceding explanation, the one or a sealing element, in particular some of the plurality of sealing elements, for example all of the plurality of sealing elements and the support device are preferably arranged such as to be moveable relative to each other. In particular thereby, the sealing element is arranged to be moveable relative to a support section of the support device in the sealing state. Preferably thereby, provision is made for the sealing element to be arranged thereon such as to be moveable relative to the support device.

In particular, due to the mutually relatively moveable arrangement of the sealing element and the support device, the effect is achieved that they are not arranged rigidly on one another and thus there is at least a certain degree of mobility therebetween and so for example, the sealing element can be arranged particularly expediently between the components that are to be sealed and can adapt thereto in order to thereby achieve a more reliable seal. In particular, due to the moveable arrangement of the sealing element and the support device relative to each other, the effect is achieved that they can be easily inserted during the assembly process and can be moved into their intended positions and, due to the mobility, a fine adjustment of the support device and of the sealing element can be effected independently of each other.

In particular, provision is made for the sealing element to be connected to the support device and to be moveable relative thereto at least in the sealing state. In particular, the advantages of the moveable arrangement are achieved thereby and moreover, due to the connection of the sealing element to the support device, the sealing element is roughly positioned in its desired position by the support device. For example, the assembly process is thereby facilitated since, due to the connection of the sealing element to the support device, they are connected to one another and are thus easier to install.

In particular, the sealing system exhibits a geometrical sealing plane. In particular, the sealing system has a seal axis which preferably runs at least approximately perpendicularly to the geometrical sealing plane.

For example, the sealing system extends substantially in the geometrical sealing plane. In particular, provision is made for a fluid, for example, a hot gas against which the sealing system is intended to provide a seal, to flow at least approximately perpendicularly to the sealing plane, for example, to flow through the sealing system. It is particularly preferred, if the sealing system seals in a direction that is axial relative to the seal axis. In the case of other advantageous embodiments, the sealing system seals in a direction that is radial relative to the seal axis.

It is particularly advantageous, at least in the sealing state, if the sealing system is formed in such a manner that the sealing element is arranged on the support device with play in the geometrical sealing plane. The arrangement of the sealing element on the support device thus exhibits a degree of play in the geometrical sealing plane. In particular, different expansion behaviours of the sealing element and of the support device which are induced for example by the effect of the hot hot-gas are thereby compensable in the geometrical sealing plane and/or stresses between the sealing element and the support device are at least diminished by the arrangement with play in the geometrical sealing plane.

In particular, provision is made for the sealing system to be formed in such a manner that, at least in the sealing state, the sealing element is arranged on the support device with play in at least one direction, in particular, in the direction that is radial relative to the seal axis and for example, is connected thereto. Thus the advantages of the arrangement with play unfold the advantages thereof in at least this one direction.

It is particularly advantageous if the sealing element is arranged on the support device in captive manner when in an assembled state, in particular is arranged thereupon with play in captive manner. For example, the support device holds the sealing element in captive manner when in the assembled state, for example with play. Preferably thereby, the sealing element and the support device, when in the assembled state, are connected to one another in force-locking manner and/or by a substance-to-substance bond and/or in positively locking manner.

In particular, the sealing system is assembled in the assembled state and when assembled is brought into the sealing state. In particular, the assembled state of the sealing system is a state thereof which it adopts before it adopts the sealing state.

Hence in particular, the sealing system is thus arranged on the support device in captive manner prior to the sealing state, whereby the assembly of the sealing system is simplified since the sealing element is arranged on the support device in captive manner and consequently only one unit consisting thereof has to be brought into the assembly position.

For example, the sealing element is also arranged on the support device in correspondingly captive manner in the sealing state.

It is particularly advantageous if an expansion space is arranged between the sealing element and the support device, for example, between the sealing element and a support section of the support device. In particular thereby, the expansion space is arranged in the form of a radial expansion space between the sealing element and the support device in a direction that is radial relative to the seal axis. Thus in particular, the expansion space makes a free space available for the play of the sealing element and the sealing element has play within the expansion space allowing it to move and/or expand for example.

In particularly advantageous embodiments, provision is made for the sealing system, in particular, the support device to comprise at least one stop. Preferably, provision is made for the play of the sealing element to extend up to the at least one stop. Thus in particular, the sealing element has play, namely in particular a substantially predetermined amount of play up to the at least one stop, whilst on the other hand the sealing element is held in the at least roughly located desired position by the at least one stop in an advantageous manner.

In some advantageous embodiments, provision is made for the sealing system to comprise at least one seating for a locating part. In particular, the arrangement of the sealing element with play on the support device is effected by means of the seating and the locating part. Thus in particular, the arrangement with play is achieved in a constructionally simple manner. For example, the sealing element is held on the support device with play due to the arrangement of the locating part in the seating.

It is particularly preferred that the seating provide at least a part of the expansion space. In particular thereby, the advantages of the seating and of the expansion space in combination are realized.

Preferably, provision is made at least in the sealing state for the locating part to be arranged in the seating such as to be moveable relative to the seating in at least one direction, preferably in a direction that is radial relative to the seal axis. In particular, the play for the sealing element is thereby made available in at least this direction.

For example, the sealing element comprises the seating and the support device comprises the locating part.

In particularly preferred embodiments, provision is made for the support device to comprise the at least one seating and for the sealing element to comprise the locating part or at least one locating part. The arrangement of the sealing element with play in the seating is thereby realized in a constructionally simple manner and the play of the locating part in the seating supplies the play for the sealing element.

In some advantageous embodiments, provision is made for the seating to be formed from a plurality of seating subspaces. Preferably, the plurality of seating subspaces are arranged such as to be displaced relative to each other, in particular, arranged such as to be to be displaced spatially from each other. In particular, the plurality of seating subspaces are connected to one another by one or more seating passageways through which the locating part engages. In particular, the effect is thereby achieved that the seating provides a free space for the play for the locating part in the plurality of seating subspaces whilst on the other hand, a captive effect is obtained due to the arrangement of the locating part in the plurality of seating subspaces which in particular are arranged such as to be displaced relative to each other.

Preferably, provision is made for the seating to comprise at least one stop, for example, the one stop of the support device. In particular thereby, the advantages of the provision of a stop are passed on to the embodiment with at least one seating.

Up to now, no particular details have been given in regard to the arrangement of the sealing element and the support device.

It is particularly preferred that the sealing element be held by the support device. For example, the sealing element is held by the support device at least in a direction that is axial relative to the seal axis. In particular, the effect is thereby achieved that, despite the arrangement with play, the sealing element is held by the support device and these thus form a unit for example. In particular, the assembly process is thereby facilitated since, in the course of positioning the support device, the sealing element held thereby is also positioned and/or whilst the sealing element still has the play with the advantages thereof in the sealing state, it is however also held by the support device at least in a rough desired position.

It is particularly advantageous if the sealing system comprises a clamping device. Preferably thereby, the arrangement with play of the sealing element on the support device is effected by means of the clamping device. Thus in particular thereby, the sealing element is arranged on the support device by means of the clamping device and, for example, is held thereby and consequently the advantages of the arrangement with play are achieved in this constructionally simple realization.

In particular, the clamping device comprises at least one clamping part which is clamped in particular at least in the sealing state. For example, the clamping part is clamped in a direction that is radial relative to the seal axis. In particularly advantageous embodiments, the clamping part is clamped in a peripheral direction surrounding the seal axis. For example, the clamping part is clamped in only one direction. In other embodiments, provision is made for the clamping part to be clamped in a plurality of directions.

Preferably, provision is made for the clamping device to comprise a clamping section or a plurality of clamping sections. In particular, the one clamping section is or the plurality of clamping sections are provided for the purposes of clamping the clamping part. For example, the one clamping section clamps the clamping part. In particular, the clamping part is clamped between the plurality of clamping sections. It is particularly advantageous, if at least some of the plurality of clamping sections are arranged such as to be displaced relative to each other, wherein, due to this in particular, a particularly expedient clamping of the clamping part is achieved. As an alternative or in addition thereto for example, provision is made for at least two clamping sections to be arranged such as to be located substantially opposite each other and the clamping part is clamped therebetween and consequently in particular, a particularly simple clamping process is realized.

In some embodiments, provision is made for the sealing element to comprise the one clamping section or the plurality of clamping sections and for the support device to comprise the at least one clamping part.

In particularly preferred embodiments, provision is made for the support device to comprise the one clamping section or at least some, for example all, of the plurality of clamping sections and in particular, for the sealing element to comprise the at least one clamping part. Consequently, the clamping part is, for example, clamped by the clamping sections, namely with play, and this play is passed on to the arrangement of the sealing element, whereby the latter is arranged with play and in captive manner on the support device.

In some advantageous embodiments, provision is made for the sealing system to comprise a connecting part. In particular, the connecting part connects the sealing element to the support device. Provision is preferably made for the sealing element to be arranged on the support device by means of the connecting part at least in the assembled state. In particular, the sealing element is thereby arranged on the support device in captive manner in a constructionally simple way and the assembly of the sealing system is simplified.

For example, the connecting part is formed such as to be at least partly resilient. In particular, the captive arrangement of the sealing element on the support device is achieved thereby but, due to the at least partial elasticity of the connecting part, play is still bestowed on the sealing element, for example, for an expansion differing from that of the support device and/or for a relative movement with respect to the support device.

In preferred embodiments, provision is made for the connecting part to comprise at least one predetermined breaking point, i.e. one predetermined breaking point or a plurality of predetermined breaking points. In particular, the at least one predetermined breaking point is formed in such a manner that it breaks away in the sealing state so that in particular, the connection between the sealing element and the support device by means of the connecting part is released in the sealing state and consequently the sealing element is arranged with play.

Up to now, no particular details in regard to the construction of the sealing element have been given.

Preferably, the sealing element is formed such as to run around the seal axis in the peripheral direction in closed manner. In particular, the sealing element thus runs in closed manner around the seal axis and seals around the seal axis and a guidance section for the fluid and in particular for the hot gas which runs at least in the region of the sealing element such as to be substantially coaxial with the seal axis.

Preferably, the sealing element comprises a main section which is intended in particular for sealing purposes. For example, the main section comprises two sealing sections which are provided in particular for respectively sealing on each side and which each seal one respective side in the sealing state. In particular, the two sealing sections each seal on a respective side of the geometrical sealing plane in the sealing state.

In particular, the two sealing sections are connected to one another by a part of the main section. For example, the main section is substantially in the form of a Z-ring. In other embodiments, the main section is substantially V-shaped.

It is particularly expedient if the two sealing sections are spaced from each other in an axial direction relative to the seal axis and for example, if the geometrical sealing plane runs therebetween. In particular, in an unloaded state such as in the assembled state for example, provision is made for the spacing between the two sealing sections, in particular, an axial spacing between the two sealing sections in an axial direction relative to the seal axis to be greater than in the sealing state. Thus in particular, the sealing sections are spaced from each other and in the sealing state, are preferably subjected to pressure so that the spacing therebetween is reduced, and hence a particularly good sealing effect is achieved due to the applied pressure.

For example, the spacing between the two sealing sections, in particular, the spacing therebetween in an axial direction relative to the seal axis amounts to at least 0.5 mm, preferably at least 1 mm and/or at most 8 mm, for example at most 5 mm in the unloaded state. It is particularly preferred that the spacing amounts to at least approximately 2 mm.

In some advantageous embodiments, provision is made for the support device to extend in an axial direction relative to the seal axis between two geometrical support end planes. In particular, the support device comprises a support bearing surface on each one of the two geometrical support end planes. Preferably, the geometrical support end planes run at least approximately parallel to each other. It is particularly expedient, if the geometrical support end planes run at least approximately perpendicularly to the seal axis.

In particular thereby, the support device has a given thickness in the direction between the support end planes, in particular, in an axial direction relative to the seal axis and, in the sealing state, serves as a spacer between the components that are to be sealed. In particular thereby, the support bearing surfaces are particularly expedient for providing a rest area for the components that are to be sealed so that a stable arrangement with reliable sealing can be achieved. In particular thereby, the main force connection is effected via the support device and the sealing element is arranged in the force shunt connection when in the sealing state.

It is particularly advantageous at least in the unloaded state if the sealing element is formed with at least one sealing section which extends over the support device in an axial direction relative to the seal axis. In particular, at least one sealing section thus projects over the support device in the unloaded state and thereby offers a point of application for the application of load. In the sealing state, provision is made in particular for the sealing

element to no longer protrude over the support device in the axial direction relative to the seal axis. In particular, in the sealing state, the sealing sections are arranged substantially in a respective one of the geometrical support end planes and there, they form the seal for the components that are to be sealed.

It is particularly advantageous, if in the unloaded state at least one of the geometrical support end planes runs between the two sealing sections and hence in particular at least one of the two sealing sections projects over the support device and thus provides a point of application for the application of load.

Preferably, the sealing element is formed at least partly and in particular entirely from a metallic material. In particular, the metallic material offers optimal properties in regard to resistance to the fluid that is to be sealed against, in particular to the hot gases and is flexible enough to provide a reliable seal.

For example the metallic material comprises nickel and is preferably a nickel alloy. In some embodiments, provision is made for the metallic material to comprise spring steel or to be spring steel.

For example. the sealing element or at least the main section thereof is formed out of sheet metal.

Up to now, no particular details have been given in regard to the construction of the support device.

Preferably, the support device is formed such as to at least partly embrace the sealing element whereby in particular, the support device embraces the sealing element at least partly circumferentially relative to the seal axis. In particular, the support device thereby offers a stable holding arrangement for the sealing element.

In particular, provision is made for the support device to comprise a support section which at least partly embraces the sealing element in an expedient manner. For example, the support section runs at least partly and preferably entirely around the sealing element circumferentially relative to the seal axis.

In particular, the support section is provided as a spacer and/or for a direct line of force in the sealing state. Consequently, a reliable seal is achieved in an expedient manner, wherein the main force connection is effected via the support device and the sealing element can be reliably sealed in the force shunt connection and is protected from the effects of an excessive, damaging force.

In particular, the support section extends between the two support end planes and comprises the support bearing surfaces therein. Preferably, the support section is of substantial construction between the support bearing surfaces. In particular thereby, the support section forms a stable spacer and the main force connection can be effected through it.

In some advantageous embodiments, provision is made for the support section of the support device to be formed in one piece manner. In particular, the effect is thereby achieved that it can be manufactured in a constructionally simple manner and is particularly stable due to the one piece construction.

In some particularly preferred embodiments, provision is made for the support device to comprise a plurality of support layers. Preferably thereby, provision is made for the support section to be formed from the plurality of support layers. In particular, an economical support device can thereby be provided. Consequently too for example, a support device of complex design, a seating with a plurality of subspaces for example, can then be easily manufactured in a constructionally simple manner.

For example, the plurality of support layers are merely placed upon one another. It is particularly preferred that the plurality of support layers be connected to one another by a substance-to-substance bond and/or in force-locking manner and/or in positively-locking manner. For example, the plurality of support layers are welded to one another, in particular, are spot welded.

Preferably, the one support layer is or the plurality of support layers are formed from a metallic material. In particular, a cost-effective metallic material such as inexpensive steel for example, can be used so as to thereby provide a cost-saving implementation of the support device.

In particular, one advantage is to be seen in that the support device, in particular the one or the plurality of support layers can be manufactured from an economical material especially as they are not directly exposed to the hot gases and a high-quality and more costly material is only needed for the sealing element which is exposed directly to the hot gases.

Preferably, the thickness of the support device in an axial direction relative to the seal axis amounts to at least 0.2 mm, preferably to at least 0.5 mm and/or to at most 3 mm, preferably at most 2 mm. For example, the thickness amounts to at least approximately 0.8 mm. For example, this thickness of the support device corresponds to the axial spacing of the two support end layer planes.

Hereinbefore and hereinafter, the formulation “at least approximately” used in connection with a a stated amount is to be understood as meaning that technically non-relevant deviations and or technically imposed deviations from the stated amount are also covered. In particular, deviations from the stated amount, from a specified value for example, of up to ±20%, preferably of up to ±10% and particularly advantageously of up to ±5%, of up to ±1% for example are also covered. In the case of specified directions or of a specified degree of parallelism for example, deviations of up to ±20°, preferably of up to ±10°, and particularly of up to ±5° are included.

Consequently, the preceding description of solutions in accordance with the invention comprises in particular the different combinations of features defined by the following consecutively numbered embodiments:

1. Sealing system (100), particularly for sealing against hot gas, comprising a sealing element (114) or a plurality of sealing elements (114) and a support device (112) for the sealing element (114) or for the sealing elements (114), wherein the sealing system (100) is formed in such a way that the one or at least one sealing element (114) is arranged on the support device (112) with play in at least one sealing state of the sealing system (100).

2. A sealing system (100) in accordance with embodiment 1, characterized in that it is formed in such a way that at least in the sealing state the one or at least one sealing element (114) and the support device (112) are arranged such as to be moveable relative to each other, wherein in particular the sealing element (114) is arranged on the support device (112) such as to be moveable relative thereto.

3. A sealing system (100) in accordance with any of the preceding embodiments, characterized in that it is formed in such a way that at least in the sealing state the one or at least one sealing element (114) is arranged on the support device (112) with play in a geometrical sealing plane (136).

4. A sealing system (100) in accordance with any of the preceding embodiments, characterized in that an expansion space is arranged between the one or at least one sealing element (114) and the support device (112), wherein in particular the expansion space is arranged between the sealing element (114) and the support device (112) in the form of a radial expansion space in a direction radial to the seal axis (122).

5. A sealing system (100) in accordance with any of the preceding embodiments, characterized in that it comprises at least one stop (242), and in that the play of the one or of the at least one sealing element (114) is up to the at least one stop (242).

6. A sealing system (100) in accordance with any of the preceding embodiments, characterized in that it comprises at least one seating (210) for a locating part (212) and in particular, the arrangement of the one or of the at least one sealing element (114) on the support device (112) with play is effected by means of the seating (210) and the locating part (212).

7. A sealing system (100) in accordance with any of the preceding embodiments, characterized in that the seating (210) provides at least a part of the expansion space.

8. A sealing system (100) in accordance with any of the preceding embodiments, characterized in that, at least in the sealing state, the locating part (212) is arranged in the seating (210) such as to be moveable relative to the seating (210) in at least one direction, in particular in a direction that is radial relative to the seal axis (122).

9. A sealing system (100) in accordance with any of the preceding embodiments, characterized in that the support device (112) comprises the at least one seating (210) and in that the one or at least one sealing element (114) comprises the locating part (212).

10. A sealing system (100) in accordance with any of the preceding embodiments, characterized in that the seating (210) is formed from a plurality of seating subspaces (226) which in particular are arranged such as to be displaced relative to each other.

11. A sealing system (100) in accordance with any of the preceding embodiments, characterized in that the at least one seating (210) comprises at least one stop (242).

12. A sealing system (100) in accordance with any of the preceding embodiments, characterized in that the one or at least one sealing element (114) is held by the support device (112), in particular, is held in a direction that is axial relative to the seal axis (122).

13. A sealing system (100) in accordance with any of the preceding embodiments, characterized in that it comprises a clamping device (310), wherein in particular the arrangement with play of the one or at least one sealing element (114) on the support device (112) is effected by means of the clamping device (310).

14. A sealing system (100) in accordance with any of the preceding embodiments, characterized in that the clamping device (310) comprises at least one clamping part (312) and in particular the clamping part (312) is clamped in a direction that is axial relative to the seal axis (122) and/or the clamping part (312) is clamped in the peripheral direction (128) surrounding the seal axis (122).

15. A sealing system (100) in accordance with any of the preceding embodiments, characterized in that the clamping device (310) comprises a clamping section or a plurality of clamping sections (314), in particular for the purpose of clamping the clamping part (312), wherein in particular at least some of the plurality of clamping sections (314) are arranged such as to be displaced relative to each other.

16. A sealing system (100) in accordance with any of the preceding embodiments, characterized in that, at least in an assembled state, the one or at least one sealing element (114) is arranged on the support device (112) by means of a connecting part (352).

17. A sealing system (100) in accordance with any of the preceding embodiments, characterized in that the connecting part (352) comprises at least one predetermined breaking point (354).

18. A sealing system (100) in accordance with any of the preceding embodiments, characterized in that the one or at least one sealing element (114) is formed such as to run around the seal axis (122) in closed manner in the peripheral direction (128).

19. A sealing system (100) in accordance with any of the preceding embodiments, characterized in that the one or at least one sealing element (114) comprises a main section (152) with two sealing sections (156, 158), wherein in particular, the main section (152) is in the form of a Z-ring.

20. A sealing system (100) in accordance with any of the preceding embodiments, characterized in that the two sealing sections (156, 158) are spaced from each other in the direction axial relative to the seal axis (122), wherein in particular, their axial spacing is greater in an unloaded state than in the sealing state.

21. A sealing system (100) in accordance with any of the preceding embodiments, characterized in that the support device (112) extends between two geometrical support end planes (192, 194) in a direction that is axial relative to the seal axis (122), wherein in particular, the geometrical support end planes (192, 194) run at least approximately perpendicularly to the seal axis (122).

22. A sealing system (100) in accordance with any of the preceding embodiments, characterized in that, in the unloaded state, the one or at least one sealing element (114) is formed with at least one sealing section (156, 158) which extends over the support device (112) in a direction that is axial relative to the seal axis (122).

23. A sealing system (100) in accordance with any of the preceding embodiments, characterized in that, in the unloaded state, at least one of the geometrical support end planes (192, 194) runs between the two sealing sections (156, 158).

24. A sealing system (100) in accordance with any of the preceding embodiments, characterized in that the one or at least one sealing element (114) is formed from a metallic material, for example is formed from a metal sheet.

25. A sealing system (100) in accordance with any of the preceding embodiments, characterized in that the support device (112) comprises a support section (184), in particular in the form of spacer and/or for a direct line of force.

26. A sealing system (100) in accordance with any of the preceding embodiments, characterized in that the support section (184) of the support device (112) is formed in one piece manner.

27. A sealing system (100) in accordance with any of the preceding embodiments, characterized in that the support device (112) comprises a plurality of support layers (172, 174), wherein in particular the support section (184) is formed from the plurality of support layers (172, 174).

28. Motor vehicle component with a sealing system (100) in accordance with any of the preceding embodiments.

Further preferred features and advantages of the invention form the subject matter of the following description of some exemplary embodiments and their graphical illustration.

### BRIEF DESCRIPTION OF THE DRAWINGS

In the drawing:

FIG. 1 shows a plan view of a support device and a sealing element in accordance with a first exemplary embodiment;

FIG. 2 a plan view of the sealing element of the first exemplary embodiment;

FIG. 3 a section as indicated in FIG. 1 through the support device and the sealing element;

FIG. 4 a plan view of a support layer of the support device of the first exemplary embodiment;

FIG. 5 a plan view of a further support layer of the support device of the first exemplary embodiment;

FIG. 6 a detailed exploded illustration of the support layers and the sealing element;

FIG. 7 a detailed enlarged illustration in accordance with FIG. 1 in the region of a seating for a locating part;

FIG. 8 a detailed enlarged illustration of the section in accordance with FIG. 3;

FIG. 9 a plan view of a variant of the first exemplary embodiment;

FIG. 10 a plan view of a further variant of the first exemplary embodiment;

FIG. 11 a plan view of a support device and a sealing element in accordance with a second exemplary embodiment;

FIG. 12 a detailed enlarged illustration in accordance with FIG. 11 in the region of a clamping device and a seating;

FIG. 13 a section as indicated in FIG. 11 through the support device and the sealing element in the region of the clamping device and the seating;

FIG. 14 a plan view of a support device and a sealing element in accordance with a third exemplary embodiment and

FIG. 15 a section as indicated in FIG. 14 through the support device and the sealing element.

### DETAILED DESCRIPTION OF THE INVENTION

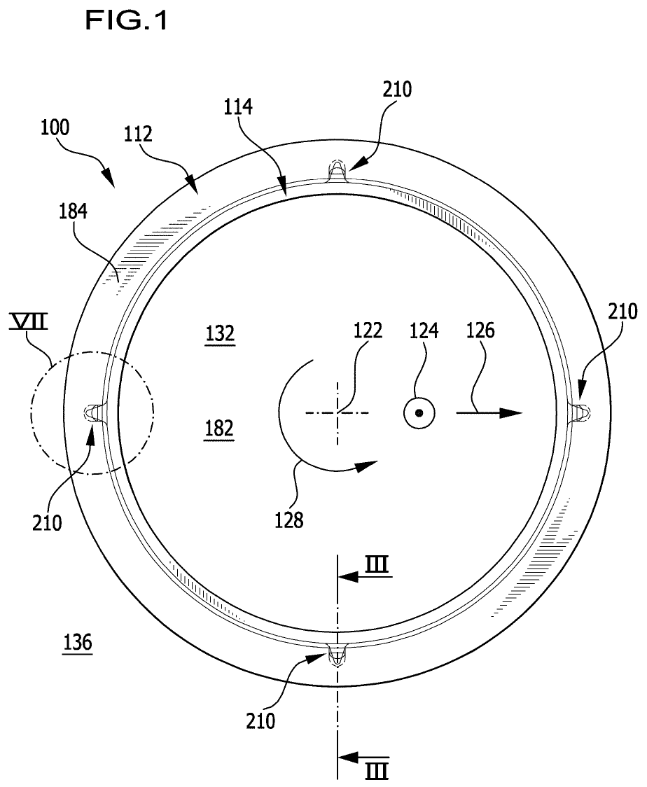

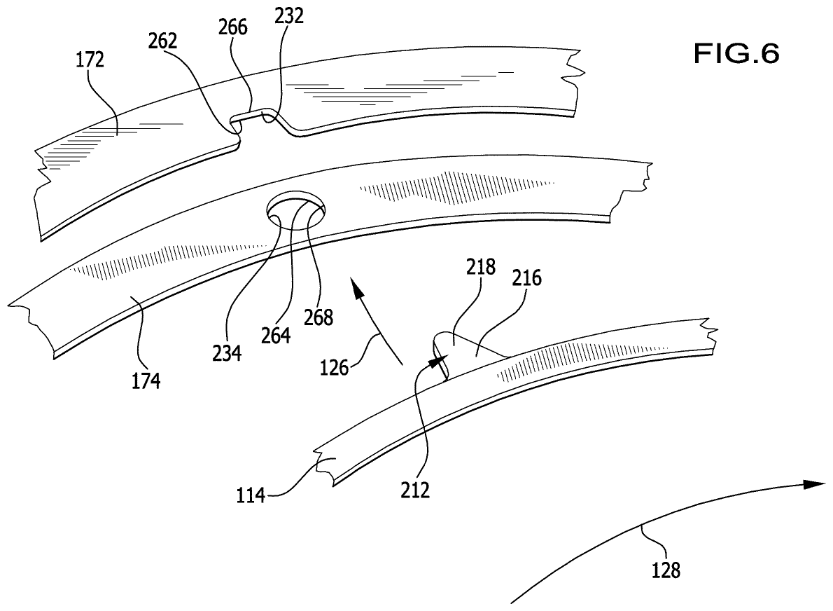

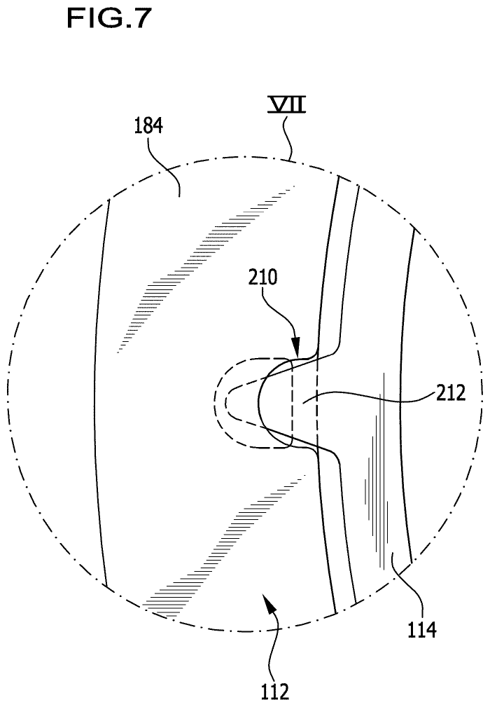

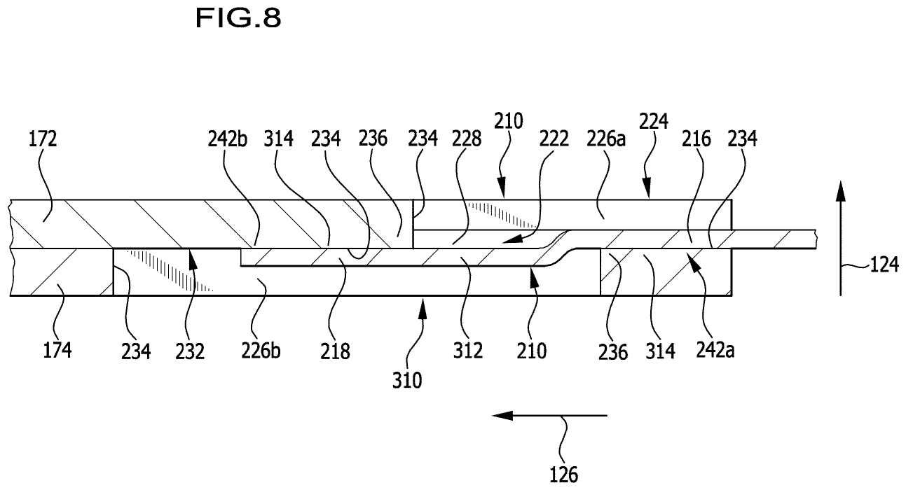

A first exemplary embodiment of a sealing system designated as a whole by 100 comprises a support device 112 and at least one sealing element 114. One variant of the exemplary embodiment is illustrated exemplarily in FIGS. 1 to 8.

The sealing system 100 is intended to seal against a fluid, in particular against hot gases, namely in particular, in the form of a seal transverse to a seal axis 122.

In particular, in an inserted state of the sealing system 100, the fluid, in particular the hot gases, flows mainly in a direction 124 that is axial to the seal axis 122, for example, through a fluid conveying channel.

The fluid conveying channel comprises a plurality of parts for example. In particular, provision is made for the sealing system 100 to seal between two parts of the fluid conveying channel.

In particular, the fluid flows substantially in the axial direction 124 in a fluid conveying region which runs substantially in the axial direction 124 at least within the area of the sealing system 100.

The fluid conveying region also extends in a direction 126 that is radial relative to the seal axis 122 and, in particular, is delimited to at least a large extent in the radial direction 126 by the parts of the fluid conveying channel.

In particular, the sealing system 100 is part of the radial delimitation of the fluid conveying region and at least in some parts thereof runs in a circumferential direction 128 around the seal axis 122.

In particular, the sealing system 100 comprises a passage opening 132 through which the seal axis 122 runs. Thus in particular, the fluid, in particular the hot gas, can pass through the passage opening 132 in a direction 124 that is substantially axial relative to the seal axis 122.

In particular, at least a part of the sealing system 100, for example at least the sealing element 114, surrounds the passage opening 132. Hereby, this part, in particular the sealing element 114, runs around the passage opening 132 in the circumferential direction 128, in particular, in a closed manner and delimits the passage opening 132 in the radial direction 126.

The sealing system 100 is in the form of a gasket for example.

In particular, the sealing system 100 extends substantially in a sealing plane 136. The sealing plane 136 runs at least approximately perpendicularly to the seal axis 122.

In particular, extents of the sealing system 100 in the sealing plane 136 are substantially greater, for example, by at least a factor of 10 greater than an extent of the sealing system 100 in a direction perpendicular to the sealing plane 136.

The sealing element 114 extends around the seal axis 122 in closed manner in particular in the circumferential direction 128.

In particular, the sealing element 114 comprises a main section 152 which likewise runs around the seal axis 122 in the circumferential direction 128.

In particular, the main section 152 surrounds the passage opening 132, in particular in the sealing plane 136.

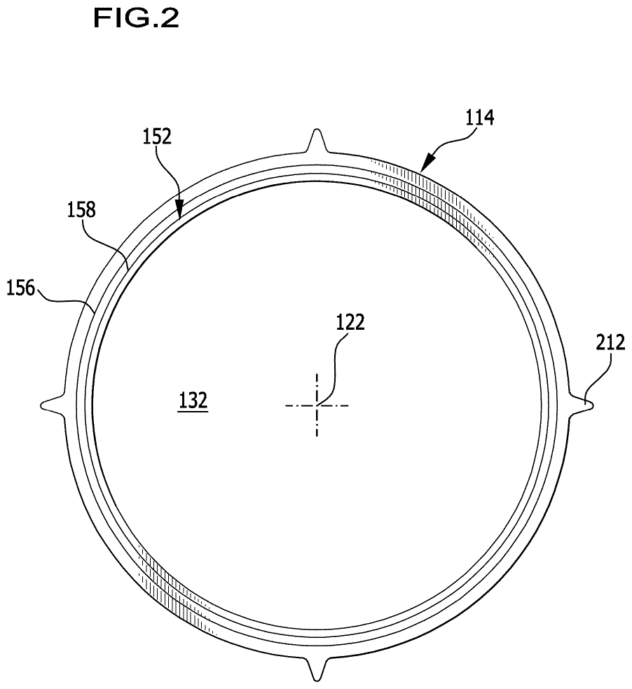

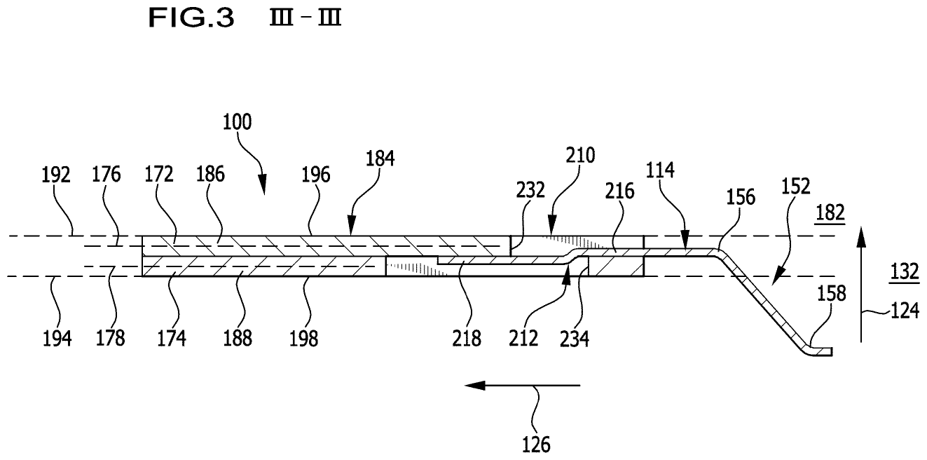

The main section 152 is intended for sealing purposes, in particular, for sealing between the two parts of the fluid conveying channel. In the installed sealing state, the main section 152 seals between these two parts in particular. Preferably, the main section 152 comprises two sealing sections 156 and 158 which in particular likewise run around the seal axis 122 in the circumferential direction 128 in closed manner (FIGS. 2 and 3).

The two sealing sections 156 and 158 are intended, in particular, for sealing on a respective side of the sealing system 100.

For this purpose, the two sealing sections 156 and 158 are arranged such as to be spaced from each other in the axial direction 124.

In particular, the sealing element 114 is made from a starting element which extends substantially over a surface area, in particular, in a geometrical plane. Preferably, the sealing element 114 is made of a sheet metal.

In particular, the sealing element 114 is formed such as to be curved at the two sealing sections 156 and 158.

Preferably thereby, the arched curvatures of the sealing sections 156 and 158 form suitable sealing surfaces. Due in particular to the bending at the sealing sections 156 and 158, the main section 152 is preferably formed such as to be resilient and in this way adapts in an optimal manner to the components that are to be sealed.

For example, the sealing element 114 is in the form of a Z-ring in the main section 152. Hereby, the main section 152 has a Z-like cross-sectional shape in a radial section. In particular, the main section 152 has a Z-like cross-sectional shape when it comprises two transverse sections which are spaced from each other in the axial direction 124 and are connected to one another at a respective edge thereof on a respective connecting part which extends transversely to the axial direction 124. In particular thereby, the sealing sections 156 and 158 are formed by the transitions of the respective transverse section into the connecting part. Preferably, the transverse sections and the connecting part run around the seal axis 122 in closed manner in the circumferential direction 128.

In the case of variants of the exemplary embodiment for example, provision is made for the main section 152 to have a V-like cross-sectional shape. In particular, a V-like main section 152 is formed by two limb sections which in particular run around the seal axis 122 in closed manner in the circumferential direction 158. In particular, the two limb sections each extend transversely relative to the circumferential direction 128 between two edges. The two limb sections are connected to one another at one of their respective edges and extend in mutually diverging manner away from their connected edges. In particular, the edges respectively located opposite the connected edges form the sealing sections 156 and 158.

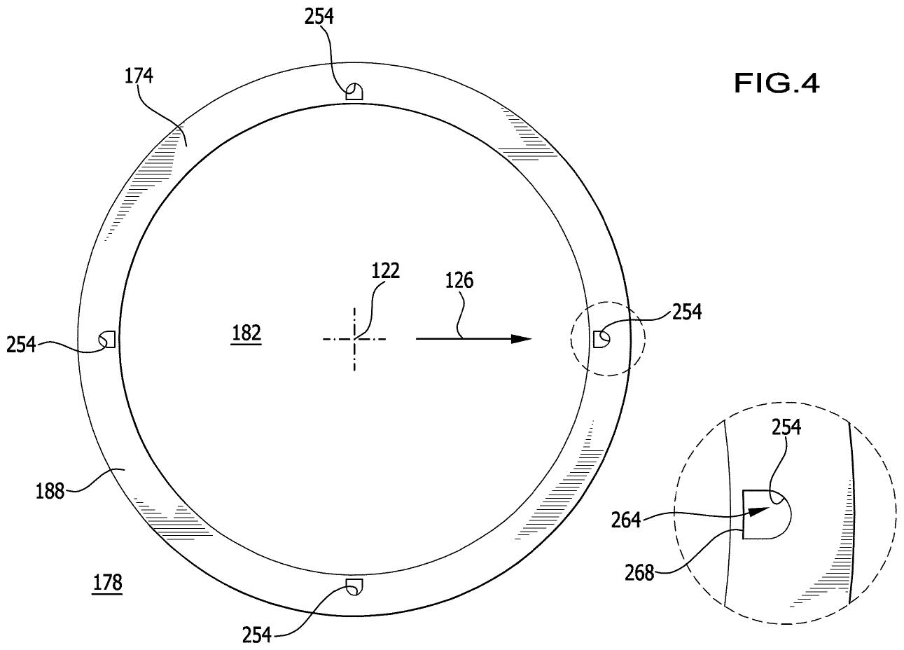

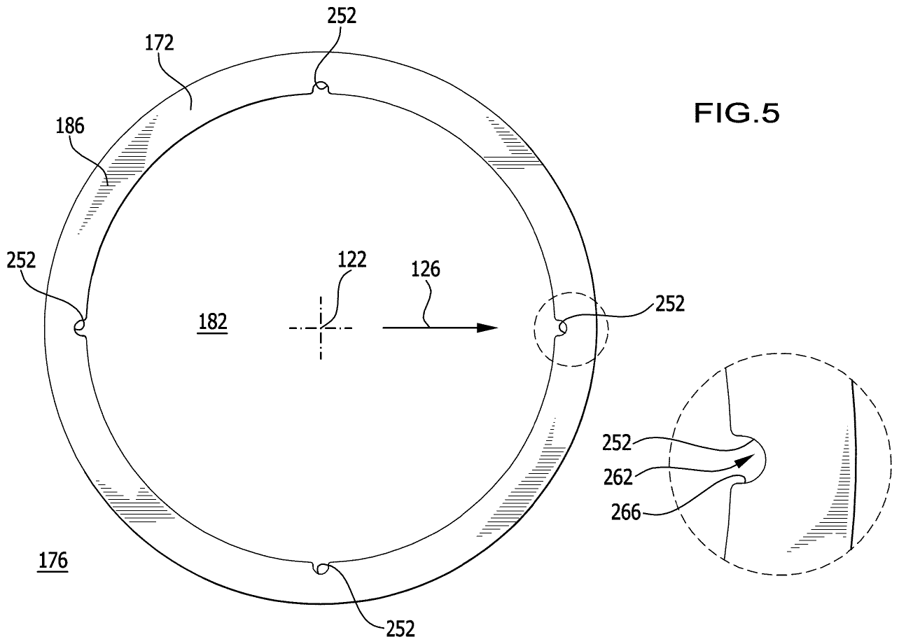

In this exemplary embodiment, the support device 112 comprises two support layers 172 and 174 and in particular is substantially formed from these two support layers 172, 174. The support layers 172, 174 are each illustrated separately by way of example in FIGS. 4 and 5.

The two support layers 172 and 174 each extend substantially in a geometrical support layer plane 176, 178. In particular thereby, an extent of the respective support layer 172, 174 in its respective support layer plane 176, 178 is substantially greater, for example by at least 10 times, in particular by at least 20 time greater than an extent of the respective support layer 172, 174 perpendicularly to its corresponding support layer plane 176, 178.

In the assembled state, the two support layers 172 and 174 are arranged in particular such as to lie on top of one another and, for example, to be connected to one another in force-locking manner and/or in positively-locking manner and/or by a substance-to-substance bond.

In particular, the two support layer planes 176 and 178 run at least approximately parallel to each other and in particular too, at least approximately parallel to the sealing plane 136 when in the assembled state.

For example, the support layers 172, 174 are each formed out of a metal sheet. Preferably, the sheet metal of the support layers 172, 174 is thicker than the sheet metal which forms the sealing element 114 and in particular its main section 152.

In particular, the support device 112 comprises a support through hole 182 which, in the assembled state, coincides at least partly with the passage opening 132.

In particular in the assembled state, the sealing element 114 and in particular its main section 152 is arranged in the support through hole 182.

Thereby, each of the support layers 172, 174 has a respective through hole which together form the support through hole 182.

In particular, the support device 112 comprises a support section 184. In this exemplary embodiment, the support section 184 is formed by a respective layer main section 186, 188 of the support layers 172, 174.

The support section 184 runs at least partly around the support through hole 182 and the support section 184 preferably runs around the support through hole in closed manner in the circumferential direction 128 and thus too around the passage opening 132.

Moreover, the support section 184 preferably runs in particular around the sealing element 114 in closed manner in the circumferential direction 128.

The support device 112 extends in the axial direction 124, in particular, between two geometrical support end planes 192 and 194. In particular, the support end planes 192 and 194 run at least approximately perpendicularly to the axial direction 124. In particular, the two support end planes 192 and 194 run at least approximately parallel to each other and in particular too, at least approximately parallel to the sealing plane 136. Moreover in particular, the support layer planes 176, 178 also run at least approximately parallel to the support end planes 192 and 194.

In particular, the support section 184 extends in the axial direction 124 from the one support end plane 192 to the other support end plane the 194 and forms a respective support bearing surface 196, 198 in these support end planes 192, 194.

Thus in this exemplary embodiment, each support layer 172, 174 forms a respective support bearing surface 196, 198 and the support layers 172, 174 adjoin each other at the respective sides thereof opposite the respective support bearing surface 196, 198.

In particular, the support section between the support bearing surfaces 196 and 198 is of substantially solid construction.

In a sealing state of the sealing system 100, the sealing element 114 is arranged on the support device 112 with play and in particular provision is also made in this exemplary embodiment for the sealing element 114 to be arranged on the support device 112 with play when in the assembled state.

The sealing system 100 comprises, in particular, at least one seating 210.

In this exemplary embodiment provision is made for the support device 112 to comprise a plurality of seatings 210, four seatings 210 for example, and consequently the sealing system 100 also comprises a plurality of seatings 210.

Hereby, the seatings are formed such as to be substantially identical in this exemplary embodiment. The following explanations in regard to “the seating 210” thus refer to each of the plurality of seatings 210. In the case of variants of the exemplary embodiment, the plurality of seatings 210 are of different constructions. For example, some of the seatings exhibit only some, the same ones or differing ones, of the features described hereinafter.

The seating 210 is intended to accommodate a locating part 212. In particular thereby, a respective locating part 212 is provided for each of the plurality of seatings 210 and so the sealing system 100 preferably comprises one locating part 212 for each seating 210.

In particular, the locating part 212 engages in the seating 210.

In this exemplary embodiment, the sealing element 114 comprises the locating parts 212, thus for example, four locating parts 212 for the four seatings 210.

For example, the locating part 212 is in the form of a planar section which in particular extends away from the main section 152 substantially in the radial direction 126.

In particular, the locating part 212 comprises an intermediate section 216 and an end section 218. In particular the locating part 212 is arranged on the main section 152 with the intermediate section 216. The intermediate section 216 extends substantially in the radial direction 126 and transitions into the end section 218 with the increasing extent of the locating part 212 in this direction. In particular, the locating part 212 extends in this direction of extent up to an end thereof located in the end section 218.

Preferably, the locating part 212 and the main section 152 are formed in one piece manner, in particular, from the same metal sheet.

In particular, the locating part 212 is in the form of a tab.

The seating 210 comprises in particular a seating space 222 which extends out from a seating opening 224.

Preferably, the seating space 222 comprises a plurality of seating subspaces 226 which are arranged such as to be displaced from each other in the axial direction 124 and the radial direction 126.

The seating subspaces 226 are connected to one another by means of a seating passageway 228. For example, the seating subspaces 226 are formed such as to be partially overlapping so that the seating subspaces 226 themselves form the seating passageway 228 in the region where they overlap.

The seating space 222 and in particular the seating subspaces 226 are delimited by a seating wall which comprises individual partial wall sections 234 and is designated as a whole by 232.

In particular, a plurality of partial wall sections 234 form projections or corners 236 in the seating space 222. In each case thereby for example, two of these partial wall sections 234 run transversely and in particular at least approximately perpendicularly to each other and form the projection 236 or the corners 236 in a transition area between the two of them.

In particular, a seating passageway 228 which connects two seating subspaces 226 to one another runs through between each two projections 236 or corners 236.

In particular, provision is made for oppositely located partial wall sections 234 which extend in particular in substantially the same directions of extent to be displaced relative to each other.

Thus in particular, the seating space 222 is in the form of a winding space comprising a plurality of seating subspaces 226.

In particular, individual partial wall sections 234 form a respective stop 242 wherein in particular, a stop 242 is formed by a projection 236 or a corner 236. For example, two stops 242a and 242b are arranged to be displaced relative to each other in the radial direction 126 and delimit a respective seating subspace 226 in the axial direction 124. In particular, a seating passageway 228 between the respective seating subspaces 226a and 226b runs between the stops 242a and 242b.

Moreover, the seating subspaces 226a and 226b delimited by the stops 242a and 242b are preferably arranged such as to be displaced relative to each other in the axial direction 124.

In particular, the stops 242a and 242b delimit their respective seating subspace 226a and 226b in the axial direction 124 with opposite orientation, so that for example the stop 242a is arranged underneath its seating subspace 226a and the stop 242b is arranged above its seating subspace 226b.

In this exemplary embodiment, the seating 210 is formed by the support layers 172, 174 of the support device 112.

For this purpose, the support layers 172, 174 each comprise recesses 252, 254 which, for example, are arranged in or are located on the respective layer main section 186, 188 in the respective support layers 172, 174.

The recesses 252, 254 each comprise a cavity 262, 264 in the respective support layer 172, 174 which is at least partly delimited by a respective edge section 266, 268 of the respective support layer 172, 174.

The cavity 262, 264 extends into the respective support layer 172, 174 in a direction of extent. In particular, the cavities 262, 264 are in the form of interconnected cavities i.e. they extend continuously in the direction of extent through the respective support layer 172, 174, preferably from one side of the respective support layer 172, 174 up to a side of the support layer 172, 174 located opposite this side in the direction of extent.

The direction of extent is, in particular, at least approximately parallel to the axial direction 124.

The recesses 252 are preferably in the form of one-sided recesses in one of the support layers, for example, in the support layer 172.

In particular, a one-sided recess 252 is formed such as to be opened transversely, in particular at least approximately perpendicularly, to the direction of extent of the cavity 262. In particular, the one-sided recess 252 is formed opened in the radial direction 126. The edge section 266 thereby only partly delimits the cavity 262 transversely, in particular at least approximately perpendicularly, to the direction of extent thereof, wherein it is formed opened in the non-delimited region of the cavity 262. For example, the cavity 262 of the one-sided recess 252 opens out into the support through hole 182.

In one of the support layers, for example the support layer 174, the recess 252 is in the form of an obversely delimited recess, wherein, in the case of the obversely delimited recess, the cavity 264 is delimited on the reverse side by the edge section 268, transversely and in particular at least approximately perpendicularly to its direction of extent. Consequently, in the case of the obverse fully delimited recess 254, the edge section 268 thus runs in particular around the cavity 264 in closed manner.

Preferably, each recess 252 of the one support layer 172 corresponds with a recess 254 of the other support layer 174, wherein the corresponding recesses 252, 254 form a common seating 210.

Preferably, mutually corresponding recesses 252, 254 are arranged such as to be displaced from each other in the different support layers 172, 174, wherein, in the case of this exemplary embodiment, these recesses 252, 254 are arranged such as to be displaced from each other in the radial direction 126. Consequently, in the assembled state, the cavities 262, 264 thereof are arranged such as to be displaced from each other in the radial direction 126 and in the axial direction 124 since the respective support layers 172, 174 are arranged such as to abut on each other in the axial direction 124.

In particular, the cavities 262, 264 each form a seating subspace and the seating wall 232 with its partial wall sections 234 is formed by the edge sections 266 and 268 of the recess 252, 254.

In particular, the recesses 252 and 254 partly overlap so that their cavities 262, 264 form the seating passageway 228 in an overlap region.

In the assembled state, the locating part 212 is accommodated in the seating 210, wherein in particular, the locating part 212 engages in the seating 210.

In particular, the locating part 212 passes through a plurality of seating subspaces 226.

For example, the intermediate section 216 runs through the seating subspace 226 formed by the one-sided recess 252, and indeed preferably from the region that is opened transversely to the direction of extent of the cavity 262 up to a region of the cavity 262 which forms the seating passageway 228. Preferably thereby, the intermediate section 216 abuts on the stop 242a which is formed by an edge section 268 of the other support layer 174.

In a transition region between the intermediate section 216 and the end section 218, the locating part 212 is preferably formed such as to be partly curved and this bent-shaped transition region runs through the seating passageway 228.

The end section 218 of the locating part 212 is arranged, in particular, in the seating subspace 226 formed by the obversely delimited recess 254. Preferably, the end section 218 rests on the stop 242b which is formed by an edge section 266 of the other support layer 172.

The seating 210 and in particular its seating space 222 is of greater extent than the locating part 212 so that the locating part 212 is accommodated with play in the seating 210.

In particular, an extent of the seating space 222 in the radial direction 126 is greater than an extent in the radial direction 126 of the portion of the locating part 212 that is accommodated in the seating 210 so that the locating part 212 can still expand or move with play into a free area of the seating space 222 in the radial direction 126.

In particular, the end section 218 is formed such as to be shorter in the radial direction 126 than an extent of the seating subspace 226 accommodating it.

In the case of one variant of the exemplary embodiment in particular, provision is made for the locating part 212 to be clamped between the two stops 242a and 242b so that this variant of the exemplary embodiment comprises a clamping device designated as a whole by 310.

The locating part 212 is thereby clamped in the form of a clamping part 312 between clamping sections 314.

The clamping sections 314 are formed by parts of the edge sections 286, in particular, by the stops 242a, 242b.

In particular, the clamping part 312 is clamped between the stops 242a and 242b that are oppositely oriented relative to the axial direction 124 and is thus clamped substantially in the axial direction 124.

For more details of a preferred construction of the clamping part 312 formed by the locating part 212 and of the clamping sections 314 formed by the edge sections 266, 268, reference should be made to the explanations in connection with the locating part 212 and the edge sections 266, 268 as well as in particular to the further explanations in connection with the seating 210, in particular, with the seating wall 232 and the stops 242.

In summary, the mode of functioning of the sealing system 100 is, in particular, substantially as follows:

The support device 112 holds the sealing element 114 with play. In particular thereby, the sealing element 114 is arranged in the support through hole 182 and the sealing element 114 surrounds the passage opening 132.

In particular, the support device 112 substantially embraces the sealing element 114 in particular by means of the support section 184, wherein a clearance space runs between the two of them so that the sealing element 114 still has room for an expansion, in particular, a thermally induced expansion, and/or an escape area is available to the sealing element 114 for positional displacements thereof.

In particular, a radial extent of the sealing element 114, in particular with exception of the regions of the locating parts 212, is formed such as to be substantially smaller than a radial extent of the support through hole 182 so that, at least in the radial direction 126, a free space which in particular is in the form of a gap runs substantially between the sealing element 114 and the support device 112 and in particular the support section 184 thereof.

For the purposes of simplifying the assembly process and for preventing loss, the sealing element 114 with the locating part 212, which engages in the seating 210 of the support device 112, is arranged thereon.

For the purposes of sealing between two components that are to be sealed, the sealing system 100 is positioned with the support device 112 and the sealing element 114 between the two components that are to be sealed and subjected to pressure whereby in particular, the components and the parts of the sealing system 100 are pressed together.

Hereby, the main force connection between the components that are to be sealed is effected by the support section 184. This is configured for this purpose and accordingly is of stable construction.

The sealing element 114 is located between the two components that are to be sealed in the direct line of force, wherein in each case, one of the sealing sections 156, 158 abuts in sealing manner on a respective one of the two components that are to be sealed.

For this purpose in particular, the main section 152 is deformed and thereby for example, the sealing section 158 projecting in the axial direction 124 over the support end plane 194 is pressed in the region between the two support end planes 194, 192 and in particular thereby, the other sealing section 156 is also pressed in sealing manner against the other component that is to be sealed.

The sealing element 114 is of course held by the support device 112, although a relative position thereof relative to the support device 112 is however still changeable due to the arrangement with play so that the process of assembling the sealing system 100 is simplified. Moreover, greater tolerances for the components can be permitted.

In the installed sealing state, hot gas in particular flows through the passage opening 132, wherein in particular, the sealing element 114 is warmed up or even heated up and there is a thermally induced expansion.

Since the sealing element 114 is arranged in a clearance space surrounding it and is held by the support device 112 with play, the sealing element 114 has a free space for the thermally induced expansion so that this is effected substantially without stresses being produced in the sealing element 114.

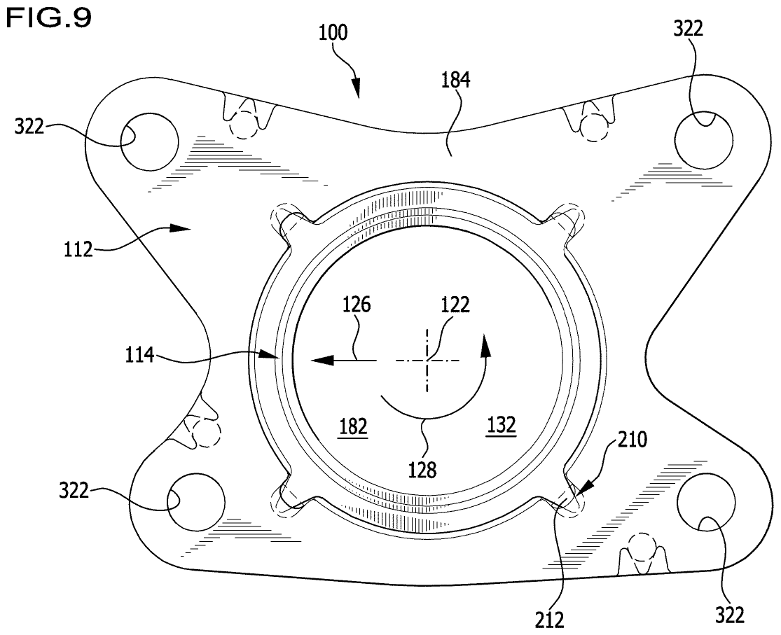

A further variant of the exemplary embodiment, in particular, in the form of a gasket in the exhaust gas system of a motor vehicle, for example, in the form of a supercharger gasket is illustrated exemplary in FIG. 9.

Again, this sealing system 100 comprises a support device 112 which holds a sealing element 114 with play.

For example thereby, the support device 112 again comprises support layers 172, 174 and comprises a support through hole 182 in which the sealing element 114 is arranged.

Moreover, the support device 112 comprises a support section 184 which in particular runs in a peripheral direction 128 around and outside the sealing element in closed manner in the radial direction 126.

The support device 112 also comprises seatings 210 for accommodating locating parts 212, wherein the sealing element 114 is held on the support device 112 with play.

Furthermore, provision is made in particular for the support device 112 to comprise fixing points 322. In particular, the fixing points 322 are provided in order to fix the support device 114 to at least one of the components that are to be sealed.

In the case of the fixing points in particular, these are through holes which are arranged in particular in the support layers 172, 174. In the assembled state, fixing means and in particular, bolts engage through these through holes and thus effect the fixing process and for example, apply additional pressure.

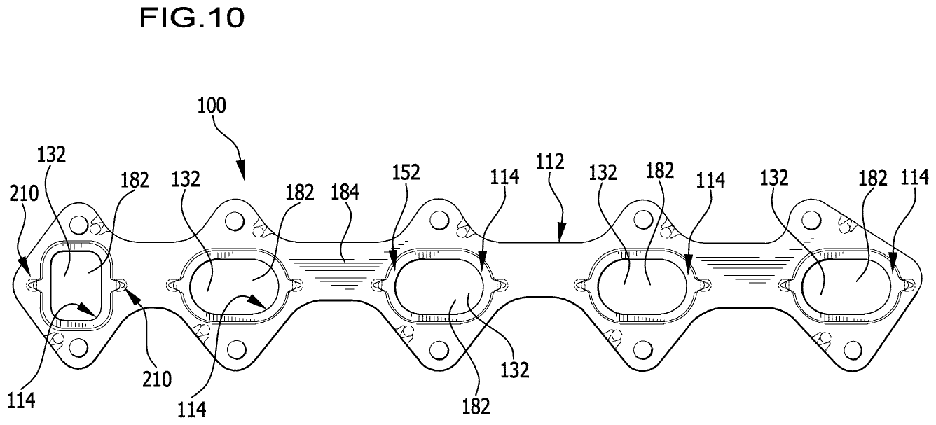

In a further variant of the exemplary embodiment which is illustrated exemplarily in FIG. 10, the sealing system 100 comprises a plurality of sealing elements 114.

In particular, this variant is also intended for sealing purposes in an exhaust gas system of a motor vehicle, for example in the form of an exhaust manifold gasket.

Each of the sealing elements 114 runs around a respective passage opening 132.

In particular, provision is made for the support device 112 to comprise a corresponding support through hole 182 for each sealing element and its appertaining sealing opening 132 in which they are arranged.

In particular thereby, provision is made for the support section 184 to run around each of the support through holes 182 at least in partial sections thereof. Preferably, a respective partial section is formed around the respective support through hole in closed manner.

For example thereby, provision is made for the support section 184 to be formed such as to extend in planar manner between two support through holes.

For example, provision is made for at least some of the sealing elements 114 and in particular the respective main section 152 thereof to have a substantially oval-like shape in an axial view or to be substantially in the form of a polygon, for example a rectangle, with rounded off corners. Thereby in particular, the main section 152 thus runs substantially along a contour which corresponds to an oval shape or to a polygon with rounded off corners.

Hereby, the loads placed on the sealing elements due in particular to the thermally induced expansion are of differing magnitudes in different part sections of the main section 152 because of the different curvature in these sections. Relief for the sealing element is thereby ensured by virtue of the arrangement thereof with play.

Furthermore, provision is preferably made for the construction of the sealing element 114 and in particular of its main section 252 to be formed in accord with the different loadings. Thus for example, the thickness of the material or the axial spacing of the sealing section 156, 158 along the extent of the main section 152 is arranged to differ.

In all other respects, all of the other features and elements in these variants are formed such as to be at least substantially the same as for the initially described variants of the exemplary embodiment together with their variations so that in regard to the description thereof reference should be made to the full content of the preceding explanations.

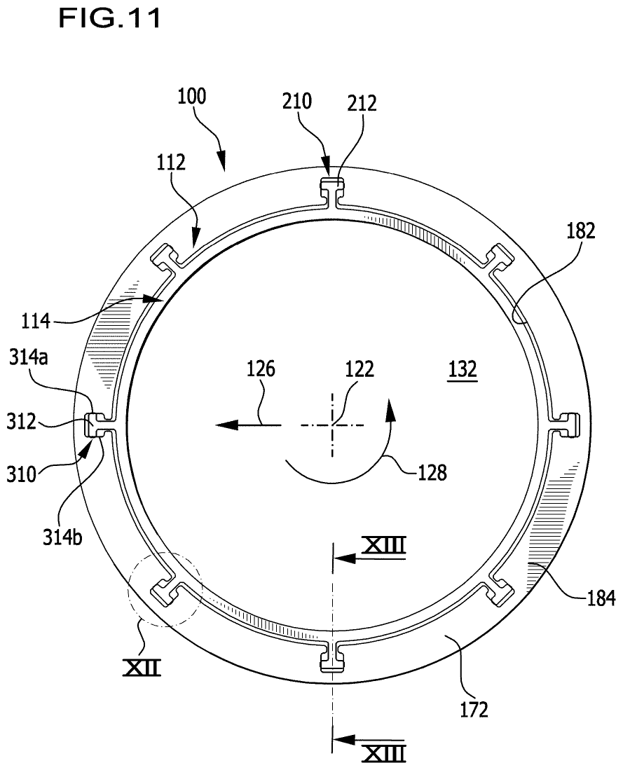

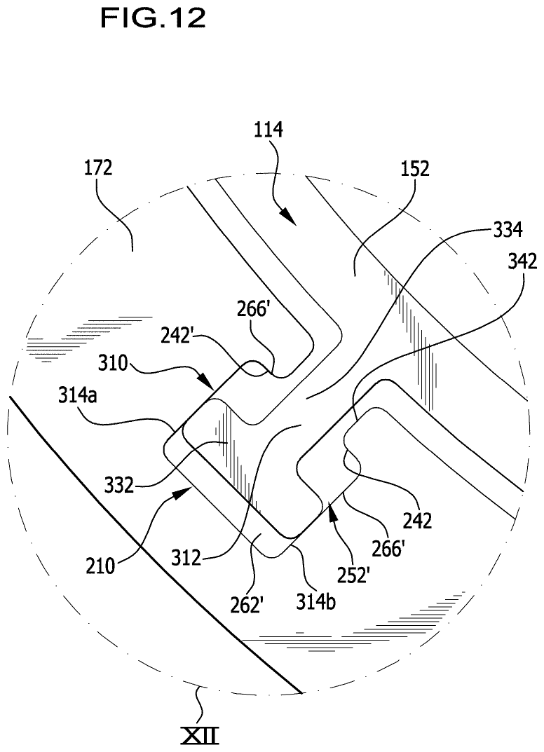

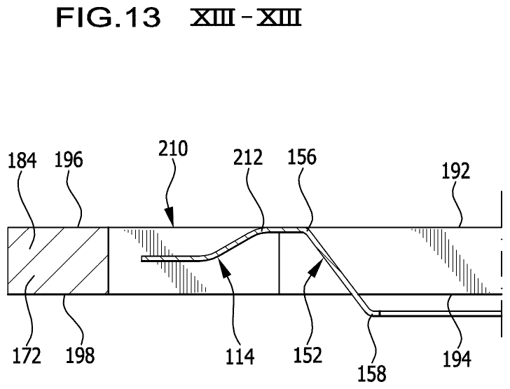

In a second exemplary embodiment which is illustrated exemplarily in FIGS. 11 to 13, those elements which are constructed at least substantially identically to the corresponding elements of the first exemplary embodiment or the function of which is at least basically the same as the corresponding elements of the first exemplary embodiment are assigned the same reference symbols as the corresponding elements in the first exemplary embodiment and in regard to the description thereof reference should be made to the explanations given in connection with the first exemplary embodiment insofar as nothing to the contrary is expressed in the following. For example, if a special indication should be given as to a variation of an element or a feature in this exemplary embodiment compared with the first exemplary embodiment then in particular, the corresponding reference symbol is provided with a dash.

In the case of this exemplary embodiment too, there is provided a support device 112, wherein a sealing element 114 is arranged in a support through hole 182 thereof.

The sealing system 100 comprises a clamping device 310 by means of which the sealing element 114 is arranged on the support device 112.

In particular thereby, a clamping part 312 is clamped between two clamping sections 314a and 314b.

The clamping part 312 comprises a spreading element 332 which is arranged between the two clamping sections 314a and 314b. In particular, the two clamping sections 314a and 314b are located opposite each other.

The spreading element 332 has a dimension in a direction of extent which is greater than a spacing between the two clamping sections 314a and 314b.

In the assembled state, the spreading element 332 is inserted between the two clamping sections 314a and 314b, namely in such a manner that its direction of extent runs substantially from the one of the clamping sections 314 to the other clamping section 114. Due to the span of the spreading element 332 in this direction of extent which is greater than the spacing of the two clamping sections 314 from each other, the spreading element 332 is thus clamped between the clamping sections 314.

Furthermore, the clamping part 312 comprises in particular a holding section 334 which holds the spreading element 332 on the main section 152.

Preferably, the clamping part 312 is formed in T-like manner, wherein the holding section 334 widens out in the transition into the spreading element 332.

For example, the clamping sections 314 are formed by edge sections 266′ of a recess 252′ in the support layer 172.

In particular, the recess 252 comprises a recess opening 342 which opens the recess 252′ to the support through hole 182 and thus to the sealing element 114.

Preferably, provision is made for a cavity 262′ of the recess 252′ to widen out and in particular to widen out in step-like manner commencing from the recess opening 342 with increasing spread into the support layer 172.

Consequently, an edge section 266′ forms a stop 242′ which is directed inwardly into the recess 252′ at the point where the cavity widens out.

Thus in particular, the support device 112 and in particular the support layer 172 also forms a seating 210 for the clamping part 312 which thus also forms a locating part 212.

By means of its holding section 334, the clamping part 312 forming the locating part 212 engages through the recess opening 342 into the recess 252′.

In particular, the spreading element 332 extends within the widened region of the cavity 262′. In the event of a movement of the clamping part 312 out of the recess 252′, it has play up to the stop 242′ and in the event of a movement of the clamping part 312 going beyond this degree of play, and in particular in the event of a movement of the entire sealing element 114 going beyond this degree of play, the clamping part 312 strikes the stop 242′ by means, in particular, of the spreading element 332 so as to prevent the clamping part 312 from slipping out of the recess 252′.

Preferably, provision is made in this exemplary embodiment for only one support layer 172 to form the support section 184 and in particular for the support device 112 to comprise just one support layer 172.

Thereby, the one support layer 172 extends between the two support end planes 192 and 194 and forms a respective support bearing surface 196, 198 in these support end planes 192, 194.

The one support layer forms 172 thereby forms at oppositely located sides thereof a respective one of the support bearing surfaces 196, 198.

Preferably, in all other respects, all of the other features and elements in this embodiment are formed such as to be at least substantially the same as for the first exemplary embodiment and/or its variants so that in regard to the description thereof reference should be made to the full content of the expositions given in connection with the first exemplary embodiment.

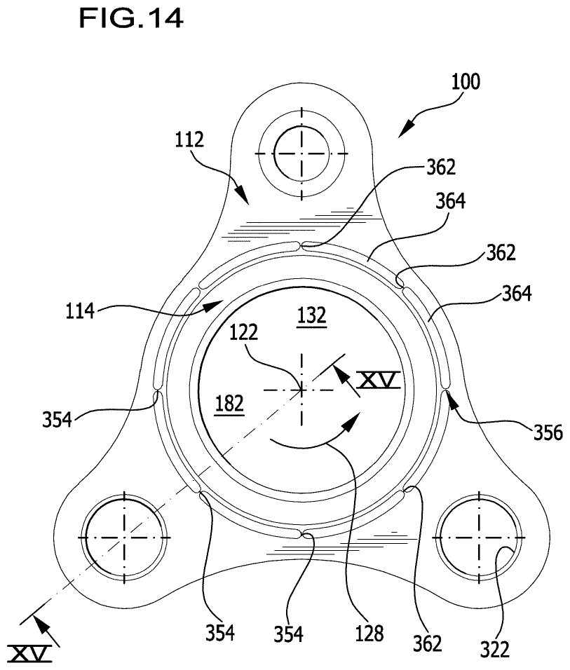

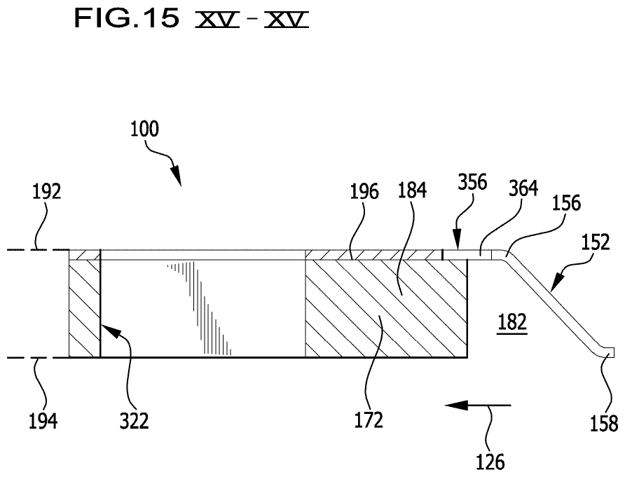

In a third exemplary embodiment, which is illustrated exemplarily in FIGS. 14 and 15, those elements which are constructed at least substantially identically to the corresponding elements of the first or second exemplary embodiment or which at least fulfil the underlying equivalent function as the corresponding elements of the first or second exemplary embodiment are assigned the same reference symbols as the corresponding elements and in regard to the description thereof reference should be made to the explanations given in connection with the first and/or second exemplary embodiment insofar as nothing to the contrary is expressed in the following.

In the case of the third exemplary embodiment too, the sealing system 100 comprises a support device 112 on which a sealing element 114 is arranged.

The support device 112 comprises a support through hole 182 in which there is arranged a main section 152 of the sealing element 114 which comprises two sealing sections 156, 158.

In particular, the support device 112 comprises a support layer 172 which forms a support section 184.

In particular, the support layer 172 extends, in particular at least in the region of the support section 184, between two support end planes 192, 194.

The support layer 172 comprises a support bearing surface 196 which extends in particular in one of the support end planes, in the support end plane 192 for example.

In particular, the support section 184 comprises the support bearing surface 196.

The sealing element 114 is arranged on the support device 112 by means of a connecting part 352. In this exemplary embodiment, provision is made for the connecting part 352 to be formed in one piece manner with the sealing element 114 and in particular with the main section 152 thereof. In the case of variants, the connecting part 352 is arranged on the sealing element 114 and they are preferably connected to one another by a substance-to-substance bond and/or in a force-locking and/or positively-locking manner.

In particular, the sealing element 114 comprising the main section 152 and the connecting part 352 is formed of a sheet metal.

For example, the connecting part 352 is formed in a substantially planar manner and abuts in particular upon the support bearing surface 196.

The connecting part 352 comprises a plurality of predetermined breaking points 354.

The predetermined breaking points 354 are arranged in a separation region 356 of the connecting part 352. The separation region runs in closed manner and in particular in ring-like manner around the main section 152 and in particular around the passage opening 132 in the peripheral direction 128.

Preferably the separation region 356 runs along an edge of the support layer 172 and in particular of the support section 184, wherein this edge delimits the support through hole 182. Consequently, the separation region 356 thus runs for example in an area of transition from the support through hole 182 to the support section 184.

The connecting part 352 is formed such as to be substantially breached in the separation region 356, and two sections of the connecting part 352 running on a respective side of the separation region 356 are connected to one another only by a plurality of webs 362.

Material-free zones 364 run between the individual webs 362 in the peripheral direction 128.

Consequently, the material-free zones 364 run in particular along the edge of the support layer 172, whereby the main section 152 that is arranged in the support through hole 182 is only connected by the individual webs 362 to a section of the connecting part 352 which abuts on the support bearing surface 196 and is connected to the support layer 172.

In an installation of the sealing system 100, the support device 112 is positioned with the sealing element 114 between the two components that are to be sealed and they are subjected to a force.

Due to the exerted force which is also effective on the connecting part 352 with the predetermined breaking points 354, the connecting part 352 breaks at the predetermined breaking points 354. Thus in particular, the webs 362 break.

Thereby, the arrangement of the predetermined breaking points 354 and thus in particular too, the arrangement of the separation region 356 on the edge of the support layer 172 is particularly expedient since the force applied to the predetermined breaking points 354 at the edge assists the breakage thereof.

Consequently, in the inserted and sealing state, the main section 152 with the sealing sections 156 and 158 is released from the support device 112 and in particular from the support layer 172 and can move and/or expand substantially freely in the support through hole 182 at least in the radial direction 126, for example, expand because of the effect of heating by the hot gases against which the sealing system 100 is sealing.

Thus, in the sealing state, the sealing element 114 is held with its main section 152 in the support through hole 182 with play. The main section 152 thereby has play to easily move about and for an expansion, a thermally induced expansion in particular.

Preferably, in all other respects, the other features and elements in this embodiment are constructed such as to be at least substantially as they were in the first and/or second exemplary embodiment or the variants thereof so that in regard to the description thereof reference should be made to the expositions given in connection with the first and second exemplary embodiment.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A sealing system, the sealing system comprising a sealing element or a plurality of sealing elements and a support device for the sealing element or for the sealing elements, wherein the sealing system is formed in such a way that at least in a sealing state of the sealing system the one or at least one sealing element is arranged on the support device with play.

2. The sealing system in accordance with claim 1, the sealing system being for sealing against a hot gas.

3. The sealing system in accordance with claim 1, wherein it is formed in such a way that at least in the sealing state the one or at least one sealing element and the support device are arranged such as to be moveable relative to each other.

4. The sealing system in accordance with claim 1, wherein the one or at least one sealing element is arranged on the support device such as to be moveable relative thereto.

5. The sealing system in accordance with claim 1, wherein an expansion space is arranged between the one or at least one sealing element and the support device.

6. The sealing system in accordance with claim 1, wherein an expansion space is arranged between the one or at least one sealing element and the support device in the form of a radial expansion space in a direction that is radial to the seal axis.

7. The sealing system in accordance with claim 1, wherein it comprises at least one stop, and in that the play of the one or the at least one sealing element is up to the at least one stop.

8. The sealing system in accordance with claim 1, wherein it comprises at least one seating for a locating part and the arrangement of the one or the at least one sealing element on the support device with play is effected by the seating and the locating part.

9. The sealing system in accordance with claim 8, wherein the seating provides at least a part of an expansion space, wherein the locating part is arranged in the seating at least in the sealing state such as to be moveable relative to the seating in at least one direction.

10. The sealing system in accordance with claim 8, wherein the support device comprises the at least one seating and the one or at least one sealing element comprises the locating part.

11. The sealing system in accordance with claim 8, wherein the seating is formed from a plurality of mutually displaced seating subspaces.

12. The sealing system in accordance with claim 1, wherein it comprises a clamping device, wherein the arrangement with play of the one or at least one sealing element on the support device is effected by the clamping device.

13. The sealing system in accordance with claim 12, wherein the clamping device comprises at least one clamping part and the clamping part is clamped in a direction that is axial relative to the seal axis and/or the clamping part is clamped in the peripheral direction surrounding the seal axis.

14. The sealing system in accordance with claim 12, wherein the clamping device comprises a plurality of clamping sections for the purposes of clamping the clamping part, wherein at least some of the plurality of clamping sections are arranged such as to be displaced relative to one another.

15. The sealing system in accordance with claim 1, wherein, at least in an assembled state, the one or at least one sealing element is arranged on the support device by a connecting part, wherein the connecting part comprises at least one predetermined breaking point.

16. The sealing system in accordance with claim 1, wherein the one or at least one sealing element comprises a main section with two sealing sections.

17. The sealing system in accordance with claim 1, wherein in the unloaded state the one or at least one sealing element is formed such that at least one sealing section extends over the support device in an axial direction relative to the seal axis.

18. The sealing system in accordance with claim 1, wherein the support device comprises a support section in the form of a spacer.

19. The sealing system in accordance with claim 1, wherein the support device comprises a support section for a direct line or force.

20. A motor vehicle component with a sealing system in accordance with claim 1.
